(19) United States
(12) Patent Application Publication
(10) Pub. No.: US 2026/0149873 A1
(43) Pub. Date: May 28, 2026

(54) ELECTRONIC DEVICE AND SYNTHETIC IMAGE GENERATION METHOD THEREOF

(71) Applicant: ASUSTeK COMPUTER INC., Taipei City (TW)

(72) Inventors: Chang-Tai Lee, Taipei City (TW); Chun-Yen Liao, Taipei City (TW)

(73) Assignee: ASUSTeK COMPUTER INC., Taipei City (TW)

(21) Appl. No.: 19/352,428

(22) Filed: Oct. 7, 2025

(30) Foreign Application Priority Data
Nov. 27, 2024 (TW) 113145669

(51) Int. Cl. H04N 23/63; G06V 10/74; H04N 23/68; H04N 23/84

(52) U.S. Cl. CPC H04N 23/633; G06V 10/761; H04N 23/683; H04N 23/84

(57) ABSTRACT

An electronic device and a synthetic image generation method thereof are provided. The method is adapted to the electronic device including an image sensor and includes the following steps. During operating in a preview mode, raw frames captured by the image sensor are recorded to a buffer. When a photographing instruction is received, consecutive frames are extracted from the raw frames in the buffer. The consecutive frames include a base frame and multiple candidate frames. By performing feature matching on the base frame and each of the candidate frames, at least one selected frame is selected from the candidate frames. Image synthesis processing is performed on the base frame and the at least one selected frame to generate a final captured image that conforms to an image storage format.

### CROSS-REFERENCE TO RELATED APPLICATION

This application claims the priority benefit of Taiwan application serial no. 113145669, filed on Nov. 27, 2024. The entirety of the above-mentioned patent application is hereby incorporated by reference herein and made a part of this specification.

### BACKGROUND

### Technical Field

This disclosure relates to a synthetic image generation method and an electronic device using the method.

### Description of Related Art

With the advancement of technology, an electronic device with an image capturing function have become prevalent in modern people's lives. To improve quality of photos, a multi-frame synthesis algorithm may be used to optimize an imaging effect. However, during a process of capturing a multi-frame image, slight shaking of a photographer or movement of an object may generate subtle differences between the multi-frame images, resulting in a final synthetic effect not being as expected (such as blur or ghosting). At present, although it is possible to reduce a probability of blurred photos by reducing exposure time or using a special lens design (such as a micro gimbal stabilizer or optical image stabilization), lowering the exposure or the special lens design may still not effectively solve the blurred photos caused by the movement of the object.

### SUMMARY

A synthetic image generation method in the disclosure, which is adapted to an electronic device including an image sensor, and the method includes the following. During operating in a preview mode, multiple raw frames captured by the image sensor are recorded to a buffer. Multiple consecutive frames are extracted from the raw frames in the buffer when a photographing instruction is received. The consecutive frames includes a base frame and multiple candidate frames. At least one selected frame is selected from the candidate frames by performing feature matching on the base frame and each of the candidate frames. Image synthesis processing is performed on the base frame and the at least one selected frame to generate a final captured image that conforms to an image storage format.

The disclosure further provides an electronic device, including an image sensor and a processor. The processor is coupled to the image sensor. The processor is configured to perform the following operations. During operating in a preview mode, multiple raw frames captured by the image sensor are recorded to a buffer. When a photographing instruction is received, multiple consecutive frames are extracted from the raw frames in the buffer. The consecutive frames includes a base frame and multiple candidate frames. At least one selected frame is selected from the candidate frames by performing feature matching on the base frame and each of the candidate frames. Image synthesis processing is performed on the base frame and the at least one selected frame to generate a final captured image that conforms to an image storage format

Based on the above, in the embodiments of the disclosure, the image sensor will output the raw frames in the preview mode, and the raw frames will be recorded to the buffer. When the photographing instruction is received, the consecutive frames including the base frame and the candidate frames may be extracted from the buffer. By performing the feature matching on the base frame and the candidate frames, the candidate frames with high feature differences may be eliminated, and the selected frames with low feature differences may be retained. The final captured image may be generated by synthesizing the base frame and the selected frame. On this basis, it is possible to avoid a phenomenon of ghosting or blurring in the final captured image generated by multi-frame synthesis processing, effectively improving photographic imaging quality. In addition, in embodiments of the disclosure, the feature matching area may be determined according to the focus point position, so as to perform the feature matching according to the partial image content that the user is concerned about. On this basis, the budget may be effectively reduced.

### BRIEF DESCRIPTION OF THE DRAWINGS

FIG. 1 is a schematic block diagram of an electronic device according to an embodiment of the disclosure.

FIG. 2 is a schematic diagram of a camera system software framework according to an embodiment of the disclosure.

FIG. 3 is a flowchart of a synthetic image generation method according to an embodiment of the disclosure.

FIG. 4 is a schematic diagram of displaying a preview image according to an embodiment of the disclosure.

FIG. 5 is a schematic diagram of extracting multiple consecutive frames from a buffer according to an embodiment of the disclosure.

FIG. 6 is a flowchart of selecting at least one selected frame according to an embodiment of the disclosure.

FIGS. 7A to 7E are schematic diagrams of feature matching areas according to an embodiment of the disclosure.

FIG. 8 is a schematic diagram of generating a final captured image according to an embodiment of the disclosure.

### DETAILED DESCRIPTION OF DISCLOSED EMBODIMENTS

Reference will now be made in detail to the exemplary embodiments of the disclosure, and examples of the exemplary embodiments are illustrated in the accompanying drawings. Whenever possible, the same reference numerals are used in the drawings and descriptions to indicate the same or similar parts. The embodiments are only a part of the disclosure and do not disclose all possible implementations of the disclosure. Rather, the embodiments are merely examples of devices and methods in the scope of claims of the disclosure.

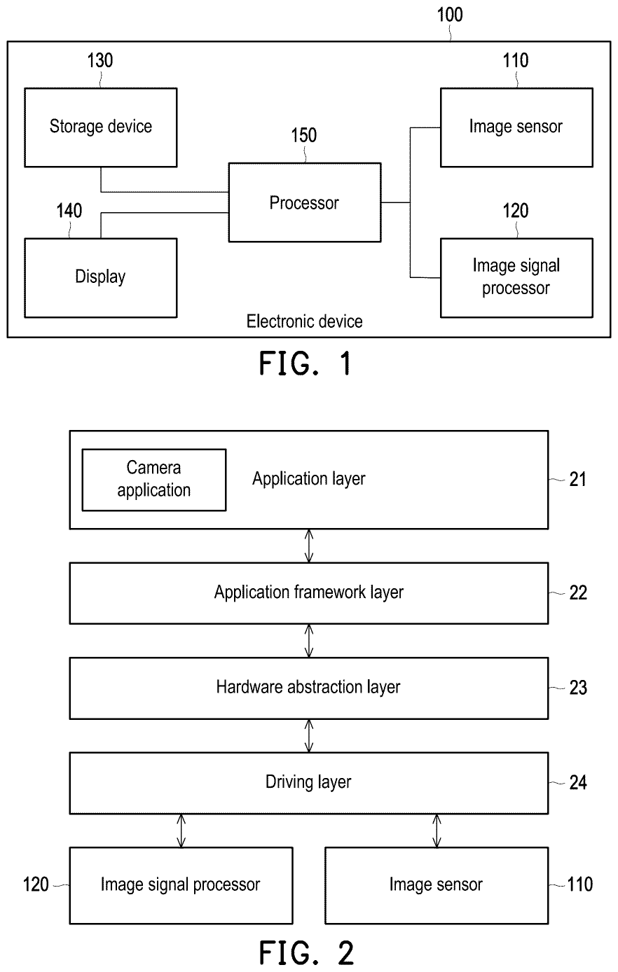

Referring to FIG. 1, an electronic device 100 may include an image sensor 110, an image signal processor (ISP) 120, a storage device 130, a display 140, and a processor 150. The electronic device 100 may be, for example, various electronic devices with an image capturing function, such as a smart phone, a digital camera, a tablet computer, a game console, an electronic wearable device, or a photography device, and a type of the electronic device 100 is not limited thereto.

The image sensor 110 is used to capture an image, and may include a lens, an image sensing element, and other components. The lens may include an optical lens, which is used to control an optical path. The image sensing element is used to provide an image sensing function. The image sensing element may include a photosensitive element, such as a charge coupled device (CCD), a complementary metal-oxide semiconductor (CMOS) element, or other elements, and the disclosure is not limited thereto. The lens may collect imaging light on the image sensing element to achieve a purpose of capturing the image.

The image signal processor (ISP) 120 is used to process image data in real time. The image signal processor 120 may perform front-end image processing on raw frame data captured by the image sensor 110. For example, the image signal processor 120 may perform image optimization processing, such as contrast enhancement, color correction, sharpening, noise removal, on the raw frame data.

The storage device 130 is used to store data such as files, images, instructions, program codes, software modules, which may be, for example, any type of fixed or removable random access memory (RAM), read-only memory (ROM), flash memory, hard disk or other similar devices, integrated circuits, or a combination thereof.

The display 140 may be various types of displays, such as a liquid crystal display (LCD), a light emitting diode (LED) display, an organic light emitting diode (OLED), and the disclosure is not limited thereto. The display 140 may be used to display a program operation interface of a camera application, a photographing preview image, a photographing result image, etc.

The processor 150 is coupled to the display 140, the image sensor 110, and the storage device 130, which is, for example, a central processing unit (CPU), an application processor (AP), other programmable general-purpose or special-purpose microprocessors, a digital signal processor (DSP), an image signal processor (ISP), a graphics processing unit (GPU) or other similar devices, an integrated circuit, or a combination thereof. In some embodiments, the processor 150 may execute the instructions or program codes in the storage device 130 to implement each of steps of a synthetic image generation method in this embodiment of the disclosure.

FIG. 2 is a schematic diagram of a camera system software framework according to an embodiment of the disclosure. Referring to FIG. 2, a camera system software framework of the electronic device 100 may include an application layer 21, an application framework layer 22, a hardware abstraction layer 23, and a driving layer 24. The application layer 21 may include a camera application CA1. The camera application CA1 allows a user to use and control camera functions. The camera application CA1 is a main interface for the user to directly interact with a camera system, such as a camera application of the smart phone. The application framework layer 22 provides an application programming interface (API) for an application in the application layer 21. For example, the application framework layer 22 may include a camera service module.

The hardware abstraction layer (HAL) 23 provides a standardized interface, allowing the upper application layer 21 and the application framework layer 22 to communicate with different hardware devices without considering details of the specific hardware. In some embodiments, the hardware abstraction layer 23 of the camera system (also known as a camera hardware abstraction layer (camera HAL)) may perform some front-end image processing etc. on the image data from the ISP 120 or the image sensor 110. The driving layer 24 may include driving programs for underlying hardware (e.g., the image sensor 110 and the ISP 120). In other words, the hardware abstraction layer 23 may be used to link the API or service modules in the application framework layer 22 with the driving programs in the driving layer 24.

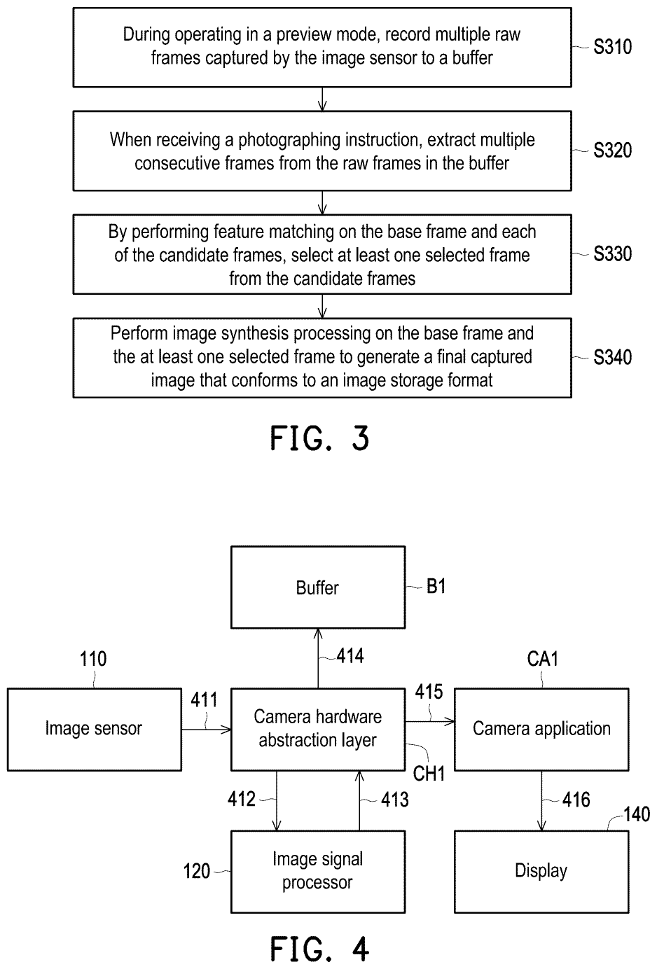

FIG. 3 is a flowchart of a synthetic image generation method according to an embodiment of the disclosure. Referring to FIG. 3, the method in this embodiment may be executed by the electronic device 100 in FIG. 1. Details of each of steps in FIG. 3 will be described below with the elements shown in FIG. 1.

In step S310, during operating in a preview mode, the processor 150 records multiple raw frames captured by the image sensor 110 to a buffer. Specifically, during the preview mode, the image sensor 110 will continuously output the raw frames. A preview image may be generated and displayed based on the raw frames, so that the user may view the preview image and decide timing and composition of a photo. In addition, the processor 150 may store the raw frames by image processing into the buffer in the preview mode. For example, the buffer may be a zero shutter lag buffer (ZSL buffer). The processor 150 may continuously record the raw frames to the buffer in the storage device 130 in sequence. The buffer may record frame sequences in a first-in-first-out manner.

In more detail, FIG. 4 is a schematic diagram of displaying a preview image according to an embodiment of the disclosure. Referring to FIG. 4, in an operation 411, during the preview mode, a camera hardware abstraction layer CH1 continuously receives the raw frames generated by the image sensor 110. In an operation 412, the camera hardware abstraction layer CH1 transmits the raw frames to the image signal processor 120, so that the image signal processor 120 may perform the front-end image processing on the raw frames and generate a YUV preview image in a YUV format. In an operation 413 and an operation 414, the camera hardware abstraction layer CH1 stores the raw frames by the front-end image processing to a buffer B1. In an operation 415, the camera hardware abstraction layer CH1 transmits the YUV preview image generated by the image signal processor 120 to the camera application CA1. In an operation 416, the display 140 will display the YUV preview image.

Returning to FIG. 3, in step S320, the processor 150 extracts multiple consecutive frames from the raw frames in the buffer when receiving a photographing instruction. In some embodiments, all or a part of the consecutive frames will be used to synthesize a final captured image with good quality or special image effects. The consecutive frames include a base frame and multiple candidate frames. That is to say, in response to the processor 150 receiving the photographing instruction issued by the user, the processor 150 may read the consecutive frames including the base frame and the candidate frames from the buffer.

Specifically, the processor 150 may identify the base frame from the buffer according to the photographing instruction, and retrieve the base frame and the candidate frames subsequent to the base frame. The disclosure does not limit the number of consecutive frames. That is to say, after the user issues the photographing instruction, the image sensor 110 may still continuously output the raw frames, and the processor 150 also continuously records the raw frames to the buffer.

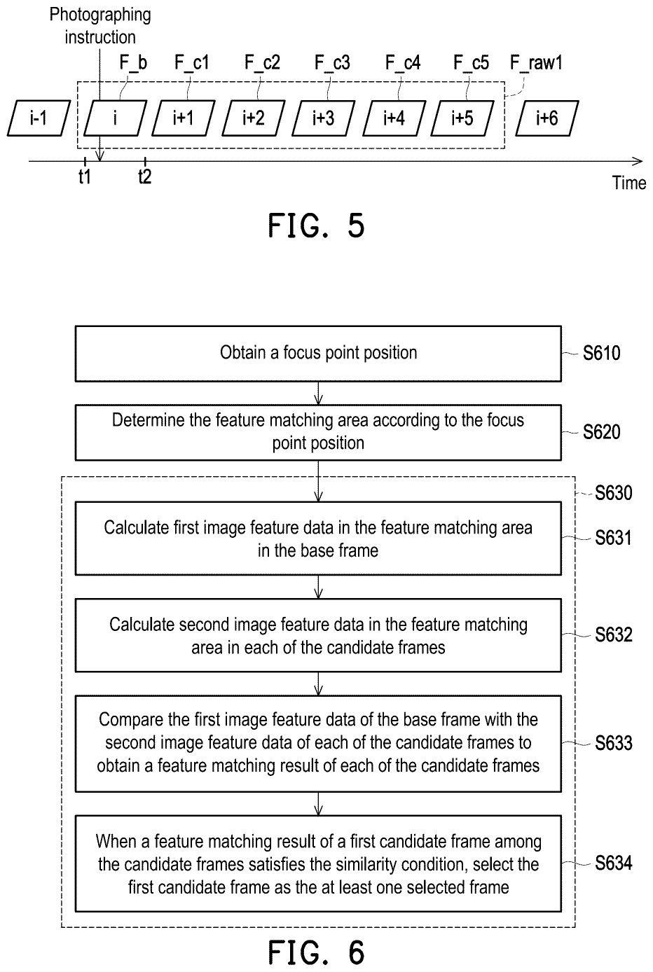

For example, referring to FIG. 5, FIG. 5 is a schematic diagram of extracting multiple consecutive frames from a buffer according to an embodiment of the disclosure. When the processor 150 receives the photographing instruction from the user between a time point t1 and a time point t2, the processor 150 may capture multiple consecutive frames F_raw1 from the buffer. In this exemplary example, the consecutive frames F_raw1 include an i-th raw frame to an i-th raw frame in the buffer. In more detail, the processor 150 may identify a corresponding base frame F_b according to the time point when the photographing instruction is issued, and extract the base frame F_b and N candidate frames F_c1 to F_c5 subsequent to the base frame F_b from the buffer. In this exemplary example, N=5, but the disclosure is not limited thereto.

Returning to FIG. 3, in step S330, the processor 150 selects at least one selected frame from the candidate frames by performing feature matching on the base frame and each of the candidate frames. That is to say, the processor 150 will use the base frame as a feature matching basis, and perform the feature matching on the candidate frames and the base frame respectively. Specifically, the processor 150 will extract image feature data of the base frame and extract image feature data of each of the candidate frames. Afterwards, the processor 150 will compare the image feature data of the base frame with the image feature data of each of the candidate frames to determine whether each of the candidate frames matches the base frame. The processor 150 may select the candidate frames that match the base frame and eliminate the candidate frames that do not match the base frame, thereby obtaining one or more selected frames.

It is worth mentioning that in some embodiments, the processor 150 may perform the feature matching on a partial area of each of the candidate frames and a partial area of the base frame, thereby significantly reducing an amount of calculation. In some embodiments, according to a focus position determined by a focus behavior, the processor 150 may dispose a feature matching area used in the feature matching.

Referring to FIG. 6, FIG. 6 is a flowchart of selecting at least one selected frame according to an embodiment of the disclosure. In some embodiments, step S330 may be implemented as step S610 to step S630.

In step S610, the processor 150 obtains a focus point position. In some embodiments, the processor 150 may determine a focus area. Specifically, in response to different focus behaviors, the processor 150 may obtain different focus areas. In different embodiments, the focus area may include a face focus area, a user-set focus area, or a preset central focus area. For example, when operating in a face focus mode, the processor 150 performs face detection to obtain the face focus area including a face object. When operating in a central focus mode, the processor 150 may obtain the preset central focus area. When t operating in a user-set focus mode, the processor 150 may obtain the user-set focus area according to the focus position selected by the user.

In some embodiments, the processor 150 may determine a focus point position according to the focus area. In some embodiments, the focus point position is a center position of the focus area. In addition, the focus point position may be other preset positions in the focus area.

In step S620, the processor 150 determines the feature matching area according to the focus point position. Furthermore, the processor 150 may determine a position of the feature matching area according to the focus point position. An area size of the feature matching area is less than a frame size. For example, assuming that a frame width of the raw frame is W, and a frame height is H, an area width of the feature matching area is 0.75*W, and an area height is 0.75*H. However, the disclosure is not limited thereto.

In some embodiments, when the focus point position matches a frame center point, the processor 150 determines the feature matching area to be a frame center area. That is to say, when the focus point position is the same as a preset center position (i.e., the frame center point), the processor 150 may determine the feature matching area to be the frame center area.

In some embodiments, the focus point position includes a first coordinate and a second coordinate, such as an X coordinate and a Y coordinate. The processor 150 may determine the position of the feature matching area by comparing the first coordinate with a first boundary position and comparing the second coordinate with a second boundary position. That is to say, the processor 150 may determine which specific frame block the focus point position falls in by comparing the X coordinate of the focus point position with the first boundary position and comparing the Y coordinate of the focus point position with the second boundary position, so as to determine the position of the feature matching area according to the specific frame block.

In some embodiments, the first boundary position may be, for example, a midpoint of the frame width, and the second boundary position may be, for example, a midpoint of the frame height. That is to say, the processor 150 may divide the frame into four quadrant blocks according to the first boundary position and the second boundary position. The processor 150 may determine the position of the feature matching area according to a certain quadrant block where the focus point position is located.

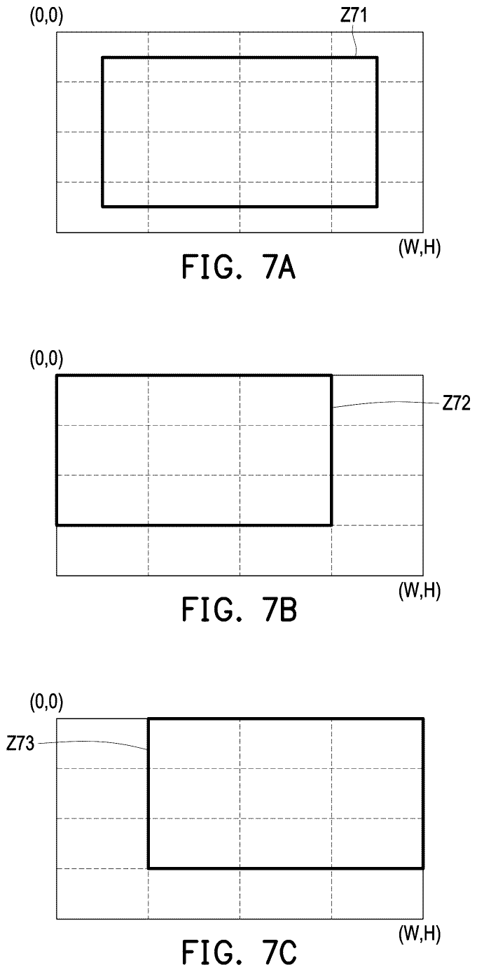

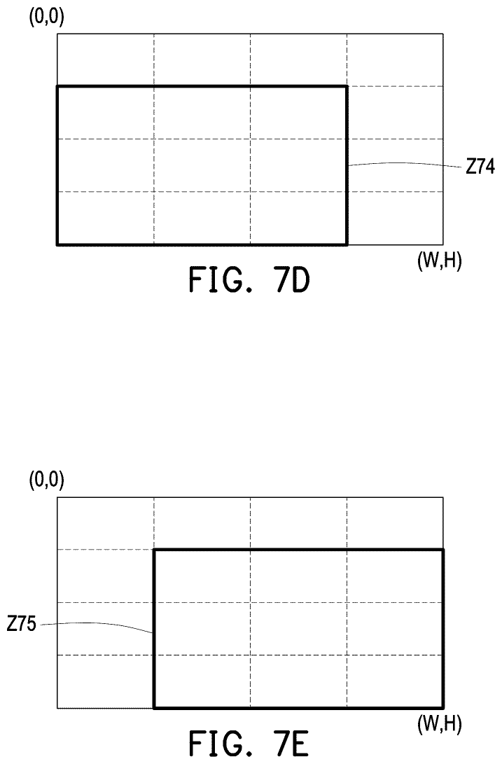

For example, FIGS. 7A to 7E are schematic diagrams of feature matching areas according to an embodiment of the disclosure. In this illustrative example, it is assumed that pixel coordinates of an upper left vertex of the frame are (0,0), and pixel coordinates of a lower right vertex of the frame are (W, H), where W is the frame width (unit: pixel), and H is the frame height (unit: pixel).

Referring to FIG. 7A, when the focus point position is the preset center position, the processor 150 may determine four area boundaries of a feature matching area Z71 to be

$$x = \frac{W}{8} , x = \frac{7 W}{8} , y = \frac{H}{8} , and y = \frac{7 H}{8}$$

respectively. That is to say, the processor 150 will perform the feature matching on a center area of the base frame and a center area of each of the candidate frames.

Referring to FIG. 7B, when the X coordinate of the focus point position is less than the first boundary position of

$$\frac{W}{2} ,$$

and the Y coordinate of the focus point position is less than the second boundary position of

$$\frac{H}{2} ,$$

the processor 150 may determine four area boundaries of a feature matching area

$$Z 72 to be x = 0 , x = \frac{3 W}{4} , y = 0 , and y = \frac{3 H}{4}$$

respectively. That is to say, the processor 150 will perform the feature matching on an upper left area of the base frame and an upper left area of each of the candidate frames.

Referring to FIG. 7C, when the X coordinate of the focus point position is greater than the first boundary position of

$$\frac{W}{2} ,$$

and the Y coordinate of the focus point position is less than the second boundary position of

$$\frac{H}{2} ,$$

the processor 150 may determine four area boundaries of a feature matching area Z73 to be

$$x = \frac{W}{4} , x = W , y = 0 , and y = \frac{3 H}{4}$$

respectively. That is to say, the processor 150 will perform the feature matching on an upper right area of the base frame and an upper right area of each of the candidate frames.

Referring to FIG. 7D, when the X coordinate of the focus point position is less than the first boundary position of

$$\frac{W}{2} ,$$

and the Y coordinate of the focus point position is greater than the second boundary position of

$$\frac{H}{2} ,$$

the processor 130 may determine four area boundaries of a feature matching area Z74 to be

$$x = 0 , x = \frac{3 W}{4} , y = \frac{H}{4} , and y = H$$

respectively. That is to say, the processor 150 will perform the feature matching on a lower left area of the base frame and a lower left area of each of the candidate frames.

Referring to FIG. 7E, when the X coordinate of the focus point position is greater than the first boundary position of

$$\frac{W}{2} ,$$

and the Y coordinate of the focus point position is greater than the second boundary position of

$$\frac{H}{2} ,$$

the processor 150 may determine four area boundaries of a feature matching area Z75 to

$$be x = \frac{W}{4} , x = W , y = \frac{H}{4} , and y = H$$

respectively. That is to say, the processor 150 will perform the feature matching on a lower right area of the base frame and a lower right area of each of the candidate frames.

In step S630, the processor 150 performs the feature matching on the base frame and each of the candidate frames according to the feature matching area. In some embodiments, step S630 may be implemented as step S631 to step S634.

In step S631, the processor 150 calculates first image feature data in the feature matching area in the base frame. In step S632, the processor 150 calculates second image feature data in the feature matching area in each of the candidate frames. In different embodiments, using various image feature extraction algorithms, the processor 150 may obtain the first image feature data in the feature matching area in the base frame and the second image feature data in the feature matching area in each of the candidate frames. The above image feature extraction algorithms are, for example, a perceptual hash (pHash) algorithm, a scale-invariant feature transform (SIFT) algorithm, or a speeded up robust features (SURF) algorithm, etc.

In step S633, the processor 150 compares the first image feature data of the base frame with the second image feature data of each of the candidate frames to obtain a feature matching result of each of the candidate frames. In some embodiments, the processor 150 may compare the first image feature data of the base frame and the second image feature data of each of the candidate frames, and determine whether the second image feature data of each of the candidate frames is similar enough to the first image feature data of the base frame.

In some embodiments, when the processor 150 calculates the first image feature data in the feature matching area in the base frame according to the perceptual hash algorithm, the processor 150 converts partial image content in the feature matching area in the base frame into a binary string (i.e., a first hash value). The first image feature data of the base frame may be the above first hash value. In the same way, the processor 150 may convert partial image content in the feature matching area in each of the candidate frames into a binary string (i.e. a second hash value). Afterwards, the processor 150 may calculate a Hamming distance between the first hash value and the second hash value of each of the candidate frames to obtain the feature matching result of each of the candidate frames.

In other embodiments, the first image feature data of the base frame may be multiple first image feature points in the feature matching area. The second image feature data of each of the candidate frames may be multiple second image feature points in the feature matching area. The processor 150 may obtain the feature matching result of each of the candidate frames according to a feature point matching algorithm. The feature matching result is, for example, the number of successful feature matches, etc.

Afterwards, the processor 150 will determine whether the feature matching result of each of the candidate frames satisfies a similarity condition. In some embodiments, the similarity condition includes being greater than a threshold value. For example, when the feature matching result of one certain candidate frame is the Hamming distance between two hash values, the processor 150 may determine whether the Hamming distance is greater than the threshold value. The threshold value may be set according to an actual application. When the feature matching result of one certain candidate frame is the number of successful feature matches, the processor 150 may determine whether the number of successful feature matches is greater than the threshold value. The threshold value may be set according to the actual application.

In step S634, the processor 150 selects the first candidate frame as the at least one selected frame when a feature matching result of a first candidate frame among the candidate frames satisfies the similarity condition. In some embodiments, the feature matching result of the first candidate frame includes a degree of feature difference between the base frame and the first candidate frame, such as the Hamming distance between the two hash values or the number of successful feature matches, etc. That is to say, the degree of feature difference between the base frame and the first candidate frame may be represented by the Hamming distance between the two hash values. In addition, the degree of feature difference between the base frame and the first candidate frame may be represented by the number of successful feature matches.

In some embodiments, when the feature matching result of one certain candidate frame satisfies the similarity condition, the processor 150 may mark a flag of the candidate frame as a first value. When the feature matching result of one certain candidate frame does not satisfy the similarity condition, the processor 150 may mark the flag of the candidate frame as a second value. Therefore, the processor 150 may retrieve the at least one selected frame for image synthesis according to the flag of each of the candidate frames.

In step S340, the processor 150 performs image synthesis processing on the base frame and the at least one selected frame to generate a final captured image that conforms to an image storage format. For example, the above image storage format is, for example, a JPEG format, but the disclosure is not limited thereto. That is to say, the candidate frames that are significantly different from the base frame will not be used for the image synthesis processing.

In some embodiments, the processor 150 may convert the base frame and the at least one selected frame into multiple YUV frames respectively. The processor 150 may perform the image synthesis processing on the YUV frames using the camera application to generate the final captured image that conforms to the image storage format, and save the final captured image. For example, the image synthesis processing of the camera application may synthesize multiple short-exposure images into one long-exposure image. In addition, the image synthesis processing performed by the processor 150 may generate an image with a high dynamic range or an image with high resolution.

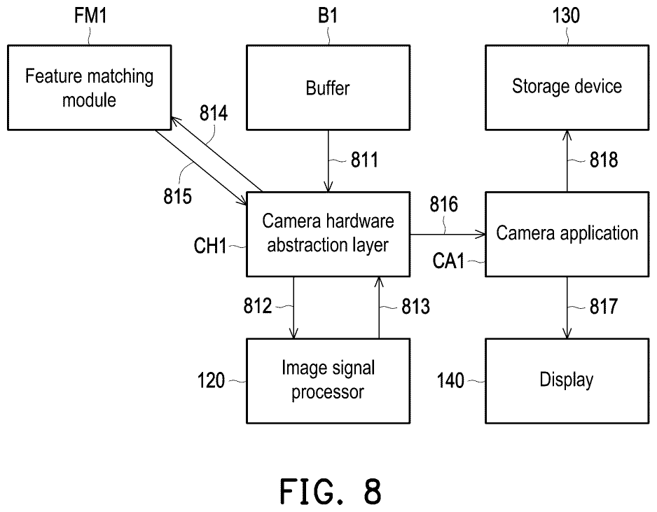

Referring to FIG. 8, FIG. 8 is a schematic diagram of generating a final captured image according to an embodiment of the disclosure. In an operation 811, the camera hardware abstraction layer CH1 reads the consecutive frames from the buffer B1 in response to the photographing instruction. In an operation 812, the camera hardware abstraction layer CH1 transmits the consecutive frames to the image signal processor 120, so that the image signal processor 120 may perform some image processing on the consecutive frames. In an operation 813 and an operation 814, the camera hardware abstraction layer CH1 may transmit the consecutive frames including the base frame and the candidate frames to a feature matching module FM1, so that the feature matching module FM1 may perform the feature matching on the base frame and each of the candidate frames according to the feature matching area. In an operation 815, the camera hardware abstraction layer CH1 may obtain the at least one selected frame selected by the feature matching module FM1, that is, the candidate frame that the flag thereof is marked as the first value. In an operation 816, the camera hardware abstraction layer CH1 may convert the base frame and the at least one selected frame into the YUV frames, and transmit the YUV frames to the camera application CA1. The camera application CA1 may perform the image synthesis processing on the base frame and the YUV frames corresponding to the candidate frames to obtain the final captured image in the YUV format. In an operation 817, the display 140 will display the final captured image in the YUV format. In an operation 818, the storage device 130 may save the final captured image that conforms to the image storage format.

Based on the above, in the embodiments of the disclosure, when the photographing instruction is received, the consecutive frames including the base frame and the candidate frames may be extracted from the buffer. By performing the feature matching on the base frame and the candidate frames, the candidate frames with high feature differences may be eliminated, and the selected frames with low feature differences may be retained. The final captured image may be generated by synthesizing the base frame and the selected frame. On this basis, it is possible to avoid a phenomenon of ghosting or blurring in the final captured image generated by multi-frame synthesis processing, effectively improving photographic imaging quality. In addition, in embodiments of the disclosure, the feature matching area may be determined according to the focus point position, so as to perform the feature matching according to the partial image content that the user is concerned about. On this basis, the budget may be effectively reduced.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A synthetic image generation method, adapted to an electronic device comprising an image sensor, wherein the method comprises:
during operating in a preview mode, recording a plurality of raw frames captured by the image sensor to a buffer;
extracting a plurality of consecutive frames from the raw frames in the buffer when receiving a photographing instruction, wherein the consecutive frames comprises a base frame and a plurality of candidate frames;
selecting at least one selected frame from the candidate frames by performing feature matching on the base frame and each of the candidate frames; and
performing image synthesis processing on the base frame and the at least one selected frame to generate a final captured image that conforms to an image storage format.

2. The synthetic image generation method according to claim 1, wherein selecting the at least one selected frame from the candidate frames by performing the feature matching on the base frame and each of the candidate frames comprises:
obtaining a focus point position;
determining a feature matching area according to the focus point position; and
performing the feature matching on the base frame and each of the candidate frames according to the feature matching area.

3. The synthetic image generation method according to claim 2, wherein obtaining the focus point position comprises:
determining a focus area; and
determining the focus point position according to the focus area, wherein the focus point position is a center position of the focus area.

4. The synthetic image generation method according to claim 3, wherein the focus area comprises a face focus area, a user-set focus area, or a preset central focus area.

5. The synthetic image generation method according to claim 2, wherein determining the feature matching area according to the focus point position comprises:
when the focus point position matches a frame center point, determining the feature matching area to be a frame center area.

6. The synthetic image generation method according to claim 2, wherein the focus point position comprises a first coordinate and a second coordinate, and determining the feature matching area according to the focus point position comprises:
determining a position of the feature matching area by comparing the first coordinate with a first boundary position and comparing the second coordinate with a second boundary position.

7. The synthetic image generation method according to claim 2, wherein performing the feature matching on the base frame and each of the candidate frames according to the feature matching area comprises:
calculating first image feature data in the feature matching area in the base frame;
calculating second image feature data in the feature matching area in each of the candidate frames; and
comparing the first image feature data of the base frame with the second image feature data of each of the candidate frames to obtain a feature matching result of each of the candidate frames.

8. The synthetic image generation method according to claim 7, wherein selecting the at least one selected frame from the candidate frames by performing the feature matching on the base frame and each of the candidate frames comprises:
selecting the first candidate frame as the at least one selected frame when a feature matching result of a first candidate frame among the candidate frames satisfies a similarity condition.

9. The synthetic image generation method according to claim 8, wherein the feature matching result of the first candidate frame comprises a degree of feature difference between the base frame and the first candidate frame, and the similarity condition comprises being greater than a threshold value.

10. The synthetic image generation method according to claim 1, wherein performing the image synthesis processing on the base frame and the at least one selected frame to generate the final captured image that conforms to the image storage format comprises:
converting the base frame and the at least one selected frame into a plurality of YUV frames respectively; and
performing the image synthesis processing on the YUV frames using a camera application to generate the final captured image that conforms to the image storage format, and save the final captured image.

11. An electronic device, comprising:
an image sensor; and
a processor coupled to the image sensor and configured to:
during operating in a preview mode, record a plurality of preview frames captured by the image sensor to a buffer;
extract a plurality of consecutive frames from the preview frames in the buffer when receiving a photographing instruction, wherein the consecutive frames comprises a base frame and a plurality of candidate frames;
select at least one selected frame from the candidate frames by performing feature matching on the base frame and each of the candidate frames; and
perform image synthesis processing on the base frame and the at least one selected frame to generate a final captured image that conforms to an image storage format.
